(19) United States
(12) Patent Application Publication
(10) Pub. No.: US 2025/0258132 A1
(43) Pub. Date: Aug. 14, 2025

(54) Systems and Methods for Sync of Instrument Voltages with Orthogonal Ion Pulsing

(71) Applicant: DH Technologies Development Pte. Ltd., Singapore (SG)

(72) Inventors: Bradley B. SCHNEIDER, Bradford (CA); Chang LIU, Richmond HIll (CA); Stephen TATE, Barrie (CA)

(21) Appl. No.: 18/856,907

(22) PCT Filed: Apr. 14, 2023
(86) PCT No.: PCT/IB2023/053811

§ 371 Date: Oct. 15, 2024

Related U.S. Application Data
(60) Provisional application No. 63/447,400, filed on Feb. 22, 2023.
(60) Provisional application No. 63/447,408, filed on Feb. 22, 2023.
(60) Provisional application No. 63/444,086, filed on Feb. 8, 2023.
(60) Provisional application No. 63/363,021, filed on Apr. 14, 2022.

(51) Int. Cl. G01N 27/623; G01N 27/624; H01J 49/00; H01J 49/40

(52) U.S. Cl. CPC G01N 27/623; H01J 49/0009; H01J 49/0031; H01J 49/0036; G01N 27/624; H01J 49/40

(57) ABSTRACT

A mass spectrometry system comprises an ion mobility separation device (IMSD) configured to receive a plurality of ions, and to perform an ejection of a set of ions of the plurality of ions by adjusting a set of mobility control parameters to a set of mobility parameter values; a mass analyzer configured to receive the set of ions, to perform a detection of the set of ions, and to generate a set of detection signals corresponding to the detection of the set of ions; and a controller configured to receive data including the set of mobility control parameter values and the set of detection signals, and to perform a mapping of the set of mobility control parameter values and the set of detection signals.

### RELATED APPLICATIONS

This application claims priority to U.S. provisional application No. 63/363,021, filed on Apr. 14, 2022, entitled “High Throughput Analysis using Ion Mobility and Mass Spectrometry,” claims priority to U.S. provisional application No. 63/444,086, filed on Feb. 8, 2023, entitled High-Throughput Analysis Using Ion Mobility and Mass Spectroscopy, claims priority to U.S. provisional application No. 63/447,400, filed on Feb. 22, 2023, entitled “Systems and Methods for High Throughput Mass Spectrometry,” and claims priority to U.S. provisional application No. 63/447,408, filed on Feb. 22, 2023, entitled “Systems and Methods for Sync of Instrument Voltages with Orthogonal Ion Pulsing.” These applications are incorporated herein by reference in their entirety.

### TECHNICAL FIELD

The present disclosure relates generally to ion detectors and more specifically to ion detectors used in high speed mass spectrometry.

### BACKGROUND

Mass spectrometry (MS) is an analytical technique for determining the elemental composition of a substance. Specifically, MS measures a mass-to-charge ratio (m/z) of ions generated from a test substance. MS may be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

Generally, a mass spectrometer may include an ion source, a mass analyzer, and a detector associated with the mass analyzer. The ion source may convert a test sample into gaseous ions, the mass analyzer may separate (or mass analyze) the gaseous ions or their fragments based on their m/z ratios, and the detector may detect the separated ions or fragments.

Recent advanced systems are able to select at very high speeds a high number of samples, ionize those samples, filter one or more precursor ions from each ionized sample, transmit those filtered precursor ions to the mass analyzer, and mass analyze those precursor ions or their fragments. The very high speeds of the advanced systems, however, pose challenges regarding the capability of the systems to analyze the results accurately.

### SUMMARY

Some embodiments relate to a mass spectrometry system including: an ion mobility separation device (IMSD) configured to: receive a plurality of ions; and perform an ejection of a set of ions of the plurality of ions by adjusting a set of mobility control parameters to a set of mobility control parameter values; a mass analyzer configured to: receive the set of ions; perform a detection of the set of ions; and generate a set of detection signals corresponding to the detection of the set of ions; and a controller configured to: receive data including the set of mobility control parameter values and the set of detection signals; and perform a mapping of the set of mobility control parameter values and the set of detection signals.

Some embodiments relate to a system, wherein: the controller is further configured to determine a set of characteristics of a selected ion included in the set of ions based on a selected set of parameters included in the set of mobility control parameter values and a selected detection signal included in the set of detection signals; the selected set of parameters are associated with an injection of the selected ion into the IMSD; and the selected set of parameters are mapped to the selected detection signal by the mapping.

Some embodiments relate to a system, wherein the set of characteristics include one or more of a chemical composition, a mass, a charge, a mass over charge ratio, and a structure of the selected ion.

Some embodiments relate to a system, wherein the IMSD includes one or more of a differential mobility spectrometer, a differential mobility analyzer, and an ion mobility spectrometer.

Some embodiments relate to a system, wherein the mass analyzer includes one or more of a quadrupole mass analyzer, a time-of-flight mass analyzer, and an ion trap mass analyzer.

Some embodiments relate to a system, wherein the set of mobility control parameters includes one or more of a compensation voltage, a separation voltage, a dispersion voltage, an energy of the set of ions, a voltage amplitude, a voltage ramp rate, an IMS drift distance, a temperature, and a transport gas composition.

Some embodiments relate to a system, wherein the controller is configured to perform the mapping based on a previously recorded mapping generated during a previous operation of the system.

Some embodiments relate to a system, wherein the previous operation of the system is performed in a calibration mode.

Some embodiments relate to a system, wherein the previous operation of the system is performed in a pulse record mode.

Some embodiments relate to a system, wherein the controller is configured to receive the previously recorded mapping as a look up table.

Some embodiments relate to a system, wherein the controller is configured to receive the previously recorded mapping as a function.

Some embodiments relate to a system, wherein the controller is further configured to: operate the system in the calibration mode; and generate the previously recorded mapping during the calibration mode.

Some embodiments relate to a system, wherein the controller is configured to perform the mapping based on a previously recorded time delay between an injection of the set of ions into the IMSD and the detection of the set of ions at the mass analyzer.

Some embodiments relate to a system, wherein the controller synchronizes a plurality of sets of detection signals with a plurality of sets of mobility control parameter values by performing the mapping of each of the plurality of sets of detection signals with each of the plurality of sets of mobility control parameter values.

Some embodiments relate to a method for performing high throughput mass spectrometry, the method including: receiving, by an ion mobility separation device (IMSD), a plurality of ions from an upstream ion source; performing, by the IMSD, an ejection of a set of ions of the plurality of ions by adjusting a set of mobility control parameters to a set of mobility control parameter values; receiving, by a mass analyzer, the set of ions; performing, by the mass analyzer, a detection of the set of ions; generating, by the mass analyzer, a set of detection signals corresponding to the detection of the set of ions; receiving, by a controller, data including the set of mobility control parameter values and the set of detection signals; and performing, by the controller, a mapping of the set of mobility control parameter values and the set of detection signals.

Some embodiments relate to a method, further including: determining a set of characteristics of a selected ion included in the set of ions based on a selected set of parameters included in the set of mobility control parameter values and a selected detection signal included in the set of detection signals, wherein: the selected set of parameters are associated with an injection of the selected ion into the IMSD; and the selected set of parameters are mapped to the selected detection signal by the mapping.

Some embodiments relate to a method, wherein the set of characteristics include one or more of a chemical composition, a mass, a charge, a mass over charge ratio, and a structure of the selected ion.

Some embodiments relate to a method, wherein the set of mobility control parameters includes one or more of a compensation voltage, a separation voltage, a dispersion voltage, an energy of the set of ions, a voltage amplitude, a voltage ramp rate, an IMS drift distance, a temperature, and a transport gas composition.

Some embodiments relate to a method, wherein the mapping is based on a previously recorded mapping generated during a previous performing of mass spectrometry.

Some embodiments relate to a method, wherein the previous performing of mass spectrometry is performed in a calibration mode.

Some embodiments relate to a method, wherein the previous performing of mass spectrometry is performed in a pulse record mode.

Some embodiments relate to a method, wherein the previously recorded mapping is stored as a look up table.

Some embodiments relate to a method, wherein the previously recorded mapping is stored as a function.

Some embodiments relate to a method, wherein the mapping based on a previously recorded time delay between an injection of the set of ions into the IMSD and the detection of the set of ions at the mass analyzer.

Some embodiments relate to a method, further including synchronizing a plurality of sets of detection signals with a plurality of sets of mobility control parameter values by performing the mapping of each of the plurality of sets of detection signals with each of the plurality of sets of mobility control parameter values.

Some embodiments relate to a method for performing mass spectrometry, the method including: introducing a sample into an ion mobility separation device (IMSD); initiating operation of the IMSD and recording an associated time; adjusting one or more operational parameters of the IMSD to allow passage of a plurality of different target ions through the ion mobility separation device over a time interval; using an ion detector of a mass spectrometer to generate a plurality of ion detection signals associated with the target ions; recording the ion detection signals and a time associated with generation of each of the ion detection signals; and utilizing calibration data and a time interval between the time associated with the initiation of the operation of the IMSD and the time associated with the detection of each of the recorded ion detection signals to correlate that ion detection signal to the one or more operational parameters of the IMSD corresponding to passage of the respective ion through the IMSD.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 schematically depicts a mass spectrometry system 100 according to various embodiments.

FIG. 2 shows a schematic of a DMS 200 utilized in combination with a mass analyzer 270 according to some embodiments.

FIG. 3 shows a flow chart for a calibration method 300 according to some embodiments.

FIG. 4 shows a flow chart for a method 400 for a high speed operation of the system according to some embodiments.

FIG. 5 schematically depicts an example of an implementation of a module 500 according to some embodiments.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

One major challenge in utilizing the very high speed advanced systems is synchronizing two sets of data; the first set of data being the data associated with operation of an ion processing device, e.g., an ion mobility separation device (IMSD), that may be positioned upstream of a mass spectrometer, and the second set of data being ion detection data collected by the mass spectrometer. Various embodiments address this challenge by providing mechanisms for synchronizing or mapping the two sets of data without reducing the speed of operation.

More specifically, some embodiments utilize an acoustic open port interface device with two downstream separation dimensions. The first separation dimension performed, for example, by an IMSD, may utilize differences or changes in ion mobility. On the other hand, the second separation dimension performed, for example, by a mass spectrometer, may utilize differences in the mass to charge ratio. The approach may include an acoustic ejection device that provides a trigger for each sample ejection. The trigger may control the start of the mobility and MS runs.

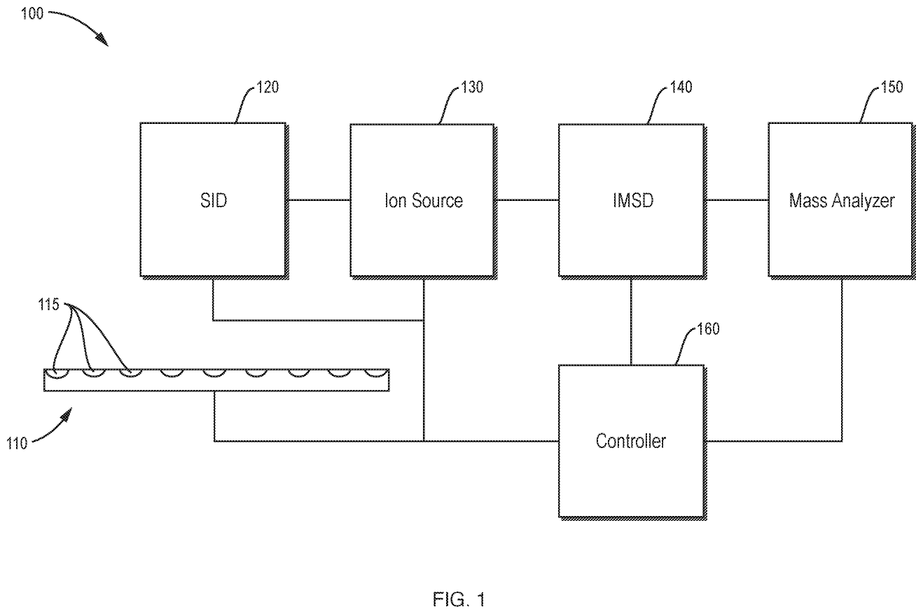

FIG. 1 schematically depicts a mass spectrometry system 100 according to various embodiments. Mass spectrometry system 100 includes a sample holder 110, a sample introducer device 120, an ion source 130, an ion mobility separation device (IMSD 140), a mass analyzer 150, and a controller 160.

Sample holder 110 may be implemented as a device that includes a plurality of reservoirs 115. In some embodiments, each reservoir 115 may be a well in which one or more samples are stored. In some embodiments, each reservoir 115 stores one type of sample but different reservoirs may store different types of samples.

Sample introducer 120 (aka a sample introduction device) may be a device that is configured to extract one or more samples from sample holder 110 (for example, from one or more of reservoirs 115) and deliver part or all of the extracted sample to ion source 130. In some embodiments, sample introducer 120 may an ejection system that utilizes one or more of different sources of energy for detaching samples from sample holder 110. Examples of those sources of energy including acoustic pulses, pneumatic pressure, heat, charged solvent droplet impact, laser heating, or another source of thermal energy.

Some embodiments may further include an optional sampling interface positioned between sample introducer 120 and ion source 130. The sampling interface may, for example, receive and dilute the sample before the sample is sent to the ion source. In various embodiments, the sampling interface may of be an Open-Port Interface (OPI) used in the Acoustic Ejection Mass Spectrometry (AEMS) technology. The OPI may, for example, receive a sample extracted from a reservoir and ejected via acoustic ejection, dilute the received sample, and transfer the sample to a downstream ion source.

Ion source 130 may be configured to ionize one or more of some target analytes that may be present in the sample that the ion source receives, and generate a plurality of ions of the target analyte. Ion source 130 may deliver those ions to IMSD 140.

IMSD 140 may be configured to separate the ions that it receives based on differences or changes in their ion mobility coefficient, which in turn may depend on various physical characteristics such as effective mass, cross section, charge, polarity, and ion/neutral interactions such as clustering and polarization.

In this manner, in some embodiments, the IMSD may play the role of a first filter for selecting some of the ions as the target ions. In various embodiments, IMSD 140 may include a Differential Mobility Spectrometer (DMS), a High Field Asymmetric Waveform Ion Mobility Spectrometer (FAIMS), a Differential Mobility Analyzer, or an Ion Mobility Spectrometer (IMS), such as a drift tube device, a trapped IMS device, a SLIM device, a travelling wave IMS device, or a cyclic IMS device. The structure and operation of a DMS is further described below. In the remainder of this disclosure, IMSD 140 may be considered to be a DMS without the loss of generality and with the understanding that other types of IMSD may replace or be added to the DMS.

Mass analyzer 150 is configured to receive target ions that are separated and ejected by IMSD 140, and analyze or detect the masses of those ions or their fragments. In various embodiments, the mass analyzer may include various types of mass spectrometers such as a quadrupole mass spectrometer, a time-of-flight (ToF) mass spectrometer, an ion trap mass analyzer, a triple quadrupole mass analyzer, a hybrid instrument including QToF or trapping instruments, such as a linear ion trap, a 3d ion trap, an Orbitrap, an electrostatic ion trap, or a combination of these with each other or other types of mass spectrometers.

In some embodiments, mass analyzer 150 may include an MS/MS mass spectrometer configured to perform MS/MS analysis of the ions that it receives from the IMSD. In such embodiments, the mass spectrometer may include a mass filter that is configured to select one or more precursor ions, and a collision cell to fragment the selected precursor ions. These fragments are then detected by an ion detector of the mass analyzer to generate ion detection signals that may then be processed to generate a mass spectrum of the fragment ions. Thus, in some cases, the ion detection signals generated by the mass spectrometer's ion detector may correspond to the detection of the ions passing through the IMSD, while in other cases, the ion detection signals may correspond to the fragment ions generated via fragmentation of the ions passing through the IMSD.

Returning to system 100 of FIG. 1, controller 160 may be a module configured to control and coordinate different operations of different parts of mass spectrometry system 100. For example, controller 160 may coordinate the extraction of a sample from the reservoirs (or more generally from the sample holder) by the sample introducer with the separation of ions of a specific target ion that is present in the extracted sample by the IMSD, and accordingly ejecting those ions from the IMSD toward the mass analyzer. In various embodiment, ejecting the ions may refer to releasing or transmitting ions from the exit of the IMSD device. Controller 160 may control the separation or selection of the ions at IMSD 140 by, for example, controlling one or more control parameters in the IMSD. In various embodiments, controller 160 may also control and coordinate operations of other parts of mass spectrometry system 100, for example, sample introducer 120, the sampling interface, ion source 130, or mass analyzer 150.

In some embodiments, to control or coordinate different operations of mass spectrometry system 100, controller 160 may utilize an operation data file. The data file may be stored on a database in the system or external to the system. The data file may, among other things, include information about various compounds or target analytes that are stored in sample holder 110, for example, in some or all of reservoirs 115. Controller 160 may utilize the information to determine the sequence of samples to extract from sample holder 110 and, for each sample, the settings and the timing for each operation of, for example, IMSD 140, mass analyzer 150, or other parts of mass spectrometry system 100.

As mentioned above, in some embodiments, the Ion mobility Separation Device (IMSD) may include a Differential Mobility Spectrometer (DMS). In some embodiments, the DMS may include a planar differential mobility spectrometer or a high field asymmetric waveform ion mobility spectrometer (conventionally referred to as FAIMS), both of which rely on the change in the ion mobility of an ion when it is subjected to a high electric field versus a low electric field range.

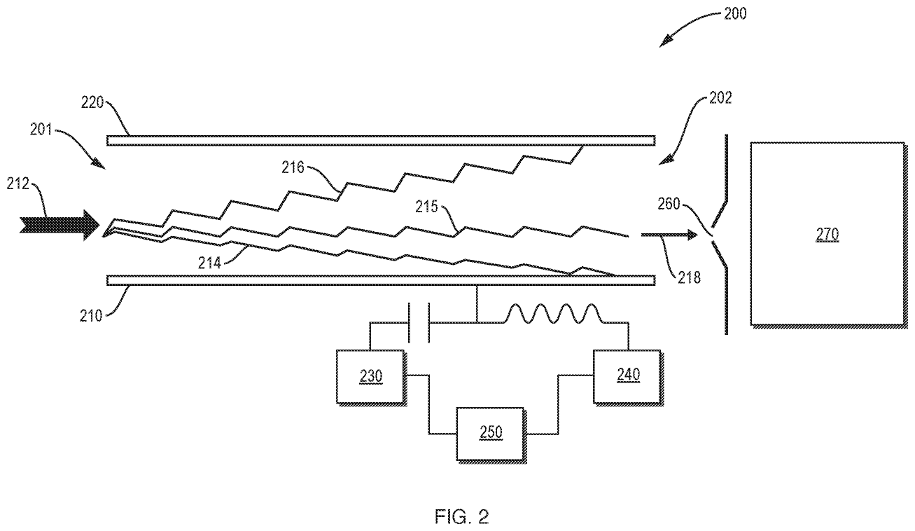

FIG. 2 shows a schematic of a DMS 200 utilized in combination with a mass analyzer 270 according to some embodiments. DMS 200 includes a first planar electrode 210, a second planar electrode 220, a separation (sometime referred to as dispersion) voltage source (SV source 230), a compensation voltage source (CoV source 240), a controller 250, and an orifice 260. FIG. 2 further illustrates an entrance area 201 and an exit area 202 for DMS 200, a transport gas flow 212, traces of two deflected ions 214 and 216, a trace of a non-deflected ion, i.e., a targeted ion 215, and an exiting ion beam 218.

First planar electrode 210 and second planar electrode 220 may be conductive plates. Moreover, SV source 230 may be a source of a time dependent electric potential, configured to generate an alternating voltage called the separation voltage (SV). Further, CoV source 240 may be another source of electric potential, configured to generate a DC voltage called the compensation voltage (CoV). FIG. 2 shows the SV and CoV applied to a single DMS electrode. In other embodiments, however, components of the SV and CoV may be applied to either electrode or split across both of the DMS electrodes.

Moreover, controller 250 may be a module that is connected to, and configured to control the operation of, some parts of DMS 200, such as one or more of SV source 230 and CoV source 240. Controller 250 may, for example, control parameters such as one or more of the time dependent magnitude and frequency of SV, the time dependence and magnitude of CoV, and the composition and volumetric flow rate of transport gas flow 212. The application of the electric potentials SV and COV to at least one DMS filter, in this case first planar electrode 210, may thus generate a time dependent electric field inside DMS 200, that is, in the space between the two conductive plates 210 and 220. During the operation of DMS 200, controller 250 may control different parameters such as SV, CoV, or temperature such that the resulting electric field filters out some of the ions and selects some other ions as target ions, as further described below. In some embodiments, the RF potential for the SV and the DC potential for the CoV may be split across electrodes 210 and 220 rather than being applied to a single electrode.

In some embodiments, transport gas flow 212 may result from a pressure difference, that is, a decreasing pressure between the entrance area and the exit area, thus causing the transport gas flow in that direction toward the orifice. In some embodiments, the pressure difference exists because the DMS is maintained at the atmospheric pressure while the downstream orifice 260 is sealed to a first chamber of mass analyzer 270, which is maintained at a first vacuum stage with a pressure that is lower than the atmospheric pressure.

During the operation of DMS 200, ions that arrive at entrance area 201 of the DMS may be driven by transport gas flow 212 toward exit area 202, and filtered via the time dependent electric field inside the DMS. In particular, to perform the filtering, controller 250 may adjust the parameters of SV, COV, temperature, transport gas flow rate, or transport gas composition such that some of the ions are deflected by the electric field toward one of the two plates, and neutralized on that plate; while other ions, the targeted ions, reach exit area 202 and pass through orifice 260 into mass analyzer 270. The schematic in FIG. 2 illustrates three such ions by showing their traces. More specifically, FIG. 2 illustrates that the time dependent electric field deflects ion 214 toward first planar electrode 210 and causes that ion to be neutralized on first planar electrode 210 before reaching exit area 202. Similarly, the time dependent electric field deflects ion 216 toward second planar electrode 220 and causes that ion to be neutralized on second planar electrode 220 before reaching exit area 202. On the other hand, the time dependent electric field causes the third ion, targeted ion 215, to remain between the two plates, reach exit area 202, pass through orifice 260, and eventually reach mass analyzer 270. The collection of such exiting targeted ions generate exiting ion beam 218.

The behavior of an ion inside DMS 200, that is, whether or not the ion is deflected toward one of the plates may depend upon the field dependent ion mobility behavior of the ion, for example, a change of the mobility coefficient of the ion in a high intensity field versus a low intensity field. That behavior may also depend upon some other factors such as the SV amplitude or waveform shape, the transport gas composition, and the temperature or pressure of the transport gas flow. The mobility coefficient of the ion may in turn depend on one or more physical characteristics of the ion such as its cross section, shape, effective mass, charge, and ion molecule effects such as clustering and polarization. These physical characteristics may affect the radial speed of the ions. Controller 250 may accordingly set the characteristics of the time dependent SV, the DC voltage CoV, or the transport gas flow such that the targeted ions are selected to pass through the DMS, while the non-targeted ions are deflected and neutralized on the plates.

Some advanced systems utilized by some embodiments are capable of performing the ion selection or mass spectrometry at such high speeds that, while increasing the potential throughput of the system, may pose challenges in areas such as analyzing the data. More specifically, in some such embodiments, the system may be capable of adjusting operational parameters of the IMSD as rapidly as feasible to sequentially select different target ions for transmission to the mass analyzer. In some embodiments, micromachined DMS devices may provide transit times on the order of 100-300 microseconds. Similarly IMS devices may generate separations with less than 1 millisecond difference in drift times. Such a high speed sequential selection of target ions for transmission to the mass spectrometer may, however, lead to absence of synchronicity between passage of target ions through the IMSD and the detection of ions by the mass spectrometer's ion detector. For example, as the ion detector is generating ion detection signals associated with one target ion of interest, another target ion may be passing through the IMSD. One challenge for the system may be associating the mass spectrometry data for a detected ion or fragment with the data corresponding to other characteristics of the ion that relate to the ion's selection at the IMSD.

Some embodiments address these challenges by providing mechanisms for synchronizing those two sets of data. More specifically, as detailed below, some embodiments operate the system in a calibration mode and generate calibration data that are indicative of the time interval between the injection of the target ion into the IMSD and the generation of ion detection signals associated with that target ion by the downstream mass spectrometer. Such calibration data may include data that map the IMSD operational parameters after the injection of the target ion and the time interval. These mapping data may then be utilized, together with the time associated with the detection of ions, to correlate the ion detection signals to the operational parameters of the IMSD.

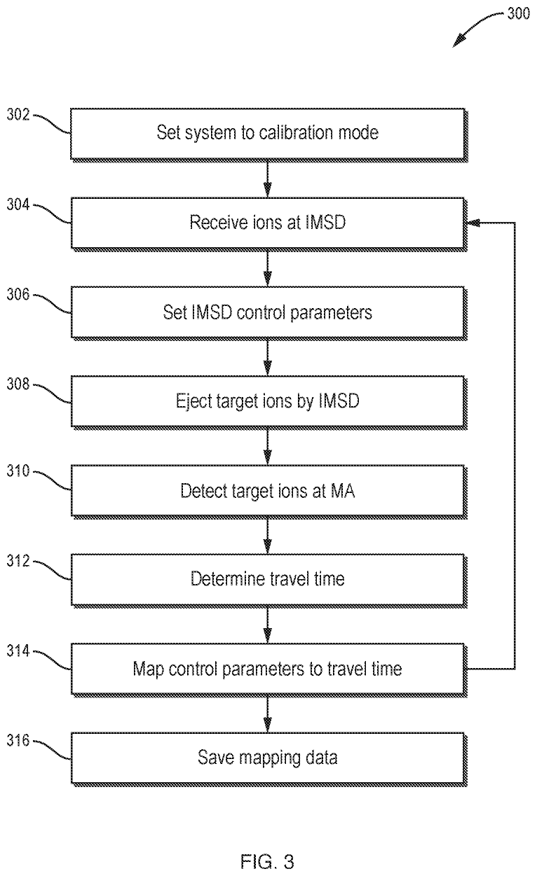

FIG. 3 shows a flow chart for a calibration method 300 according to some embodiments. In some embodiments, calibration method 300 is performed by one or more parts of the mass spectrometry system. For example, method 300 may be performed by the controller in collaboration with other parts of the system as detailed below.

Regarding the details of method 300, at step 302 the controller sets the system in a calibration mode. In some embodiments, in the calibration mode the controller may record different parameters during the operation of the system. In some embodiments, for operating in the calibration mode, the mass spectrometry system may be set up to perform all steps of the mass spectroscopy on one or more samples that are similar to those analyzed during a normal operation. In this process, a travel time may be determined as the time interval between the injection of a sample into the IMSD and the arrival or the detection of the corresponding ions at the detector.

At step 304, the controller starts one operation cycle by setting the IMSD to receive ions that are injected into it. In some embodiments, during each operation cycle of a plurality of cycles, the system may select one of the reservoirs and analyze the sample in that reservoir.

At step 306, the controller sets the values of one or more control parameters of the IMSD to filter one or more target ions from among the ions that it receives. For example, in some embodiments the IMSD may be a DMS and the one or more parameters may be one or both of the SV and CoV of the DMS.

At step 308, the IMSD operates based on the values set for the control parameters and accordingly one or more target ions are injected into it. The IMSD also records the time of the injection. The timing of the injection can be determined in a number of ways including measuring ion current at the IMSD entrance to determine when an injection has occurred.

At step 310, the mass analyzer detects the ions that are received from the IMSD at step 308 and records the time of their detection. For example, if the mass analyzer is a time of flight (ToF) mass analyzer, the ToF mass analyzer may record the time associated with a pulse applied to an ion deflector of the ToF mass analyzer, which leads to the generation of the ion detection signal.

At step 312, the controller receives from the IMSD and the mass analyzer the times of the injection of the ions into the IMSD and their detection at the mass analyzer, as recorded at steps 308 and 310, respectively. The controller determines the difference between these two times as the travel time (in some embodiments called the flight time or the drift time) for the ions from the entrance of the IMSD to the mass analyzer. In various embodiments, the travel time may vary depending, for example, on the type of the IMSD device. For instance micromachined DMS devices may have flight times on the order of 100 s of microseconds, while long path length IMS devices may have drift times on the order of a second or more.

At step 314, the controller generates a mapping between the value of the control parameters (as set at step 306 and used at step 308) and the travel time (as determined at step 312). The mapping may be in the form of a look up table, a function, a fitting graph, a software interface with input and output fields, etc. More specifically, the mapping data may provide a mechanism for determining the travel time of an ion based on the values of the control parameters that are utilized by the IMSD device, or the type or nature of the ions being injected. The mapping may determine the travel time as a function of one or more parameters such as the ion's molecular weight, shape, collision cross section, charge state, or another physicochemical property. In some embodiments, the mapping may relate to various operating parameters of the devices (e.g., mass spectrometer or IMSD). In embodiments that utilize a DMS or related devices, it may also be possible to derive a mapping that calibrates separation/dispersion or compensation voltages of the device.

Upon completion of one cycle at step 314, the controller may circle back to step 304 and start a new cycle for a new set of target ions. During the calibration mode, the system may provide sufficient pause time between consecutive cycles such that the controller may associate the detection at step 310 of each cycle with the ejection at step 308 of the same cycle and thus correctly determine the travel time at step 312.

At step 316, after completing the cycles for the samples considered for calibration, the controller may save the mapping data for future use. More specifically, the system may use the mapping data during the high speed operation of the system as further described below. In various embodiments, the system may perform calibration method 300 once for each system setup and a range of control parameter values, and subsequently utilize those data for the high speed operations of the same system setup.

Such correlation may be utilized in post processing of mass data to analyze the data, as discussed in more detail below. In various embodiments, such correlation data allows continuous acquisition of mass data at high speed and recording the data in a datafile including the time associated with the recordation of each ion detection signal. Subsequently, the calibration data may be utilized to process the recorded mass data.

For example, the datafile may include for each measurement cycle, the time at which the IMSD is triggered to initiate data acquisition, and for each ion detection signal, the time at which the ion detection signal was generated in addition to certain characteristics of the ion detection signal, e.g., its intensity, linewidth, etc. The data may then be utilized in combination with the calibration data to correlate each ion detection signal with a target ion. For example, the time associated with the generation of an ion detection signal relative to the trigger time associated with the IMSD may be utilized to identify the operational parameter(s) of the IMSD corresponding to the ion detection signal. By way of example, in various embodiments, as the variation of the SV and CoV of the IMSD as a function of time relative to the trigger time is known, the arrival time of the ions at the detector relative to the trigger time may identify the SV and CoV values associated with the ion detection signal.

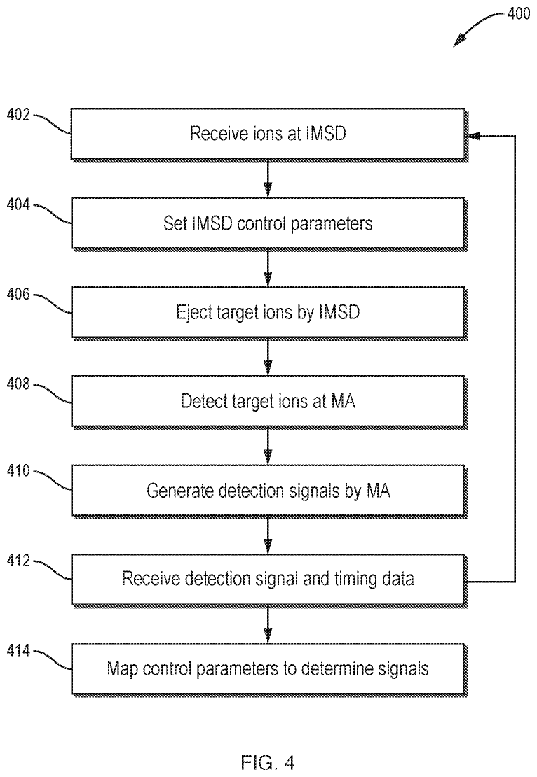

FIG. 4 shows a flow chart for a method 400 for one such high speed operation of the system according to some embodiments. In method 400, steps 402, 404, 406, and 408 are respectively similar to steps 304, 306, 308, and 310 in method 300. That is, during these steps in each cycle the system operates by receiving the ions at the entrance of the IMSD, setting the values of one or more control parameters of the IMSD and accordingly ejecting one or more target ions, and detecting those target ions at the mass analyzer.

At step 410, the mass analyzer generates detection signals corresponding to the detected ions. In various embodiments, the detection signals may indicate some characteristics of the detected ions such as their mass to charge ratio or their number. The detection signal may, for example, include a time of flight value and an electrical intensity of the detection signal.

After completion of step 410, the system may circle back to step 402 and start a new cycle. More specifically, unlike the calibration mode operation of method 300, during the high speed operation of method 400, the system may not pause between consecutive cycles in order to store and associate the data corresponding to the ejection operation and the detection operation in the same cycle. By avoiding such a pause the system may be able to maintain the high speed of analyzing many samples, for instance with speeds of 1 sec or less per sample.

Instead of storing and associating the data that correspond to the injection operation and the detection operation in the same cycle, the system may save those data separately in order to be mapped later. More specifically, as indicated at step 412, the controller may collect and save data that correspond to each injection operation into the IMSD and each detection operation by the mass analyzer separately. The data that correspond to each injection operation may include the values of the control parameters that the IMSD utilized after each injection and the time of the injection. The data that correspond to each detection, on the other hand, may include the detection signals and the time of the detection.

At step 414, the controller may perform a mapping operation on the injection data and the detection data that have been collected during multiple cycles. This mapping operation may be performed after the system has completed some or all of the cycles corresponding to some or all of the samples being analyzed.

More specifically, during the mapping operation, the controller may generate a one to one relationship between a subset of the stored injection operations and a subset of the stored detection operations. To that end, the controller may utilize the mapping data previously generated for the system during a calibration operation described in method 300. That is, for each injection operation, the controller may read the values of the control parameters and feed those values to the mapping data to receive the corresponding travel time. Then, the controller may add that travel time to the time of the injection to derive the expected time of the detection. The controller may then identify, from among the stored detection operation, a detection operation for which the time of detection is within a tolerance range of the expected time of detection. In various embodiments, the tolerance range may be zero or more generally may be a positive value less than 10 milliseconds, 1 millisecond, 500 microseconds, 300 microseconds, 100 microseconds, etc. In some embodiments, the tolerance range may be selected to be a fraction of, or more generally less than or equal to, the transit time between consecutive injections.

As a result of the mapping operation, the controller may be able to associate the set of values of the control parameters and the corresponding detection signals to the target ions that were received into the IMSD at each injection operation. The combination of the values of the control parameters and the detection signals may enable determining various characteristics of the ions such as their structure and composition.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud,” to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

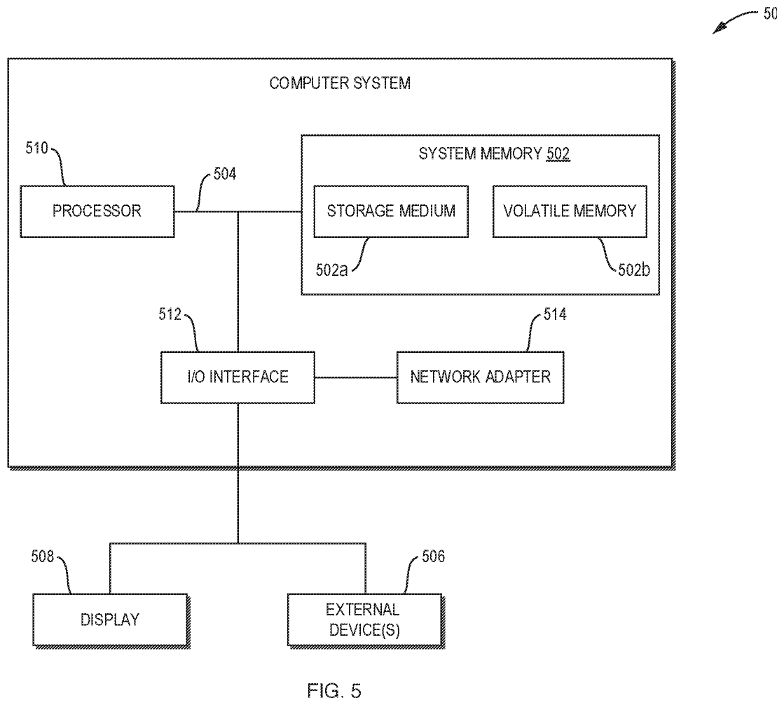

By way of example, FIG. 5 schematically depicts an example of an implementation of a module 500 according to some embodiments. Module 500 includes a system memory 502 that may include a permanent memory module (e.g., ROM 502a) and a transient memory module (e.g., RAM 502b), an internal bus 504, a processor 510 (e.g., a microprocessor), an I/O interface 512, and a communication interface 514 (such as a network adapter). I/O interface 512 may be in communication with one or more external input devices 506 (such as a mouse, a keyboard, or a touch screen) or output devices 508 (such as a display, a printer, or a speaker).

Processor 510 and system memory 502 may be utilized to store and execute instructions performing the function of module 500. Moreover, internal bus 504 may enable communication between the processor and other parts of module 500 such as system memory 502, I/O interface 512, or communication interface 514.

Although some aspects have been described in the context of a system and/or an apparatus, it is clear that these aspects may also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer, or an electronic circuit. In some embodiments, some one or more of the most important method steps may be executed by such an apparatus.

Those having ordinary skill will appreciate that various changes may be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A mass spectrometry system comprising:
an ion mobility separation device (IMSD) configured to:
receive a plurality of ions; and
perform an ejection of a set of ions of the plurality of ions by adjusting a set of mobility control parameters to a set of mobility control parameter values;
a mass analyzer configured to:
receive the set of ions;
perform a detection of the set of ions; and
generate a set of detection signals corresponding to the detection of the set of ions; and
a controller configured to:
receive data including the set of mobility control parameter values and the set of detection signals; and
perform a mapping of the set of mobility control parameter values and the set of detection signals.

2. The system of claim 1, wherein:
the controller is further configured to determine a set of characteristics of a selected ion included in the set of ions based on a selected set of parameters included in the set of mobility control parameter values and a selected detection signal included in the set of detection signals;
the selected set of parameters are associated with an injection of the selected ion into the IMSD; and
the selected set of parameters are mapped to the selected detection signal by the mapping.

3. The system of claim 2, wherein the set of characteristics include one or more of a chemical composition, a mass, a charge, a mass over charge ratio, and a structure of the selected ion.

4. The system of claim 1, wherein the IMSD comprises one or more of a differential mobility spectrometer, a differential mobility analyzer, and an ion mobility spectrometer, or
wherein the mass analyzer includes one or more of a quadrupole mass analyzer, a time-of-flight mass analyzer, and an ion trap mass analyzer.

5. (canceled)

6. The system of claim 1, wherein the set of mobility control parameters includes one or more of a compensation voltage, a separation voltage, a dispersion voltage, an energy of the set of ions, a voltage amplitude, a voltage ramp rate, an IMS drift distance, a temperature, and a transport gas composition.

7. The system of claim 1, wherein the controller is configured to perform the mapping based on a previously recorded mapping generated during a previous operation of the system.

8. The system of claim 7, wherein the previous operation of the system is performed in a calibration mode, or
wherein the previous operation of the system is performed in a pulse record mode.

9. (canceled)

10. The system of claim 7, wherein the controller is configured to receive the previously recorded mapping as a look up table, or
wherein the controller is configured to receive the previously recorded mapping as a function.

11. (canceled)

12. The system of claim 8, wherein the controller is further configured to:
operate the system in the calibration mode; and
generate the previously recorded mapping during the calibration mode.

13. The system of claim 1, wherein the controller is configured to perform the mapping based on a previously recorded time delay between an injection of the set of ions into the IMSD and the detection of the set of ions at the mass analyzer.

14. The system of claim 1, wherein the controller synchronizes a plurality of sets of detection signals with a plurality of sets of mobility control parameter values by performing the mapping of each of the plurality of sets of detection signals with each of the plurality of sets of mobility control parameter values.

15. A method for performing high throughput mass spectrometry, the method comprising:
receiving, by an ion mobility separation device (IMSD), a plurality of ions from an upstream ion source;
performing, by the IMSD, an ejection of a set of ions of the plurality of ions by adjusting a set of mobility control parameters to a set of mobility control parameter values;
receiving, by a mass analyzer, the set of ions;
performing, by the mass analyzer, a detection of the set of ions;
generating, by the mass analyzer, a set of detection signals corresponding to the detection of the set of ions;
receiving, by a controller, data including the set of mobility control parameter values and the set of detection signals; and
performing, by the controller, a mapping of the set of mobility control parameter values and the set of detection signals.

16. The method of claim 15, further comprising:
determining a set of characteristics of a selected ion included in the set of ions based on a selected set of parameters included in the set of mobility control parameter values and a selected detection signal included in the set of detection signals, wherein:
the selected set of parameters are associated with an injection of the selected ion into the IMSD;
the selected set of parameters are mapped to the selected detection signal by the mapping; and
optionally, the set of characteristics include one or more of a chemical composition, a mass, a charge, a mass over charge ratio, and a structure of the selected ion.

17. (canceled)

18. The method of claim 15, wherein the set of mobility control parameters includes one or more of a compensation voltage, a separation voltage, a dispersion voltage, an energy of the set of ions, a voltage amplitude, a voltage ramp rate, an IMS drift distance, a temperature, and a transport gas composition.

19. The method of claim 15, wherein the mapping is based on a previously recorded mapping generated during a previous performing of mass spectrometry.

20. The method of claim 19, wherein the previous performing of mass spectrometry is performed in a calibration mode, or
wherein the previous performing of mass spectrometry is performed in a pulse record mode.

21. (canceled)

22. The method of claim 19, wherein the previously recorded mapping is stored as a look up table, or
wherein the previously recorded mapping is stored as a function.

23. (canceled)

24. The method of claim 15, wherein the mapping based on a previously recorded time delay between an injection of the set of ions into the IMSD and the detection of the set of ions at the mass analyzer.

25. The method of claim 15, further comprising synchronizing a plurality of sets of detection signals with a plurality of sets of mobility control parameter values by performing the mapping of each of the plurality of sets of detection signals with each of the plurality of sets of mobility control parameter values.

26. A method for performing mass spectrometry, the method comprising:
introducing a sample into an ion mobility separation device (IMSD);
initiating operation of the IMSD and recording an associated time;
adjusting one or more operational parameters of the IMSD to allow passage of a plurality of different target ions through the ion mobility separation device over a time interval;
using an ion detector of a mass spectrometer to generate a plurality of ion detection signals associated with the target ions;
recording the ion detection signals and a time associated with generation of each of the ion detection signals; and
utilizing calibration data and a time interval between the time associated with the initiation of the operation of the IMSD and the time associated with the detection of each of the recorded ion detection signals to correlate that ion detection signal to the one or more operational parameters of the IMSD corresponding to passage of the respective ion through the IMSD.
